(19) United States
(12) Patent Application Publication
(10) Pub. No.: US 2008/0140771 A1
(43) Pub. Date: Jun. 12, 2008

(54) SIMULATED ENVIRONMENT COMPUTING FRAMEWORK

(75) Inventors: Attila Vass, Foster City, CA (US); Benbuck Nason, Castro Valley, CA (US); John P. Bates, Redwood City, CA (US); James E. Marr, Burlingame, CA (US); Ivy Tsai, San Jose, CA (US)

Correspondence Address: JOSHUA D. ISENBERG;JDI PATENT, 809 CORPORATE WAY, FREMONT, CA, 94539, US

(73) Assignee: Sony Computer Entertainment Inc., Tokyo (JP)

(21) Appl. No.: 11/929,681

(22) Filed: Oct. 30, 2007

Related U.S. Application Data
(60) Provisional application No. 60/869,294, filed on Dec. 8, 2006.

(51) Int. Cl. G06F 15/16

(52) U.S. Cl. 709/203; 709/201

(57) ABSTRACT

Apparatus and systems for implementing simulated environments are disclosed. Remote implementation of function calls is also disclosed. A simulated environment apparatus may include a plurality of simulation servers coupled to each other over data transfer links. The simulation servers may be configured to perform computations related to simulating an environment. A plurality of view servers may be coupled to the simulation servers over data transfer links. Each view server is configured to facilitate interaction between a plurality of client devices and the simulation servers. Each user device may control an avatar within the simulated environment. A simulated environment system may include a data center configured to communicate over a network with one or more remotely distributed client devices.

### CROSS-REFERENCE TO RELATED APPLICATIONS

This application claims the benefit of priority to U.S. Provisional Patent Application 60/869,294 to Attila Vass et al entitled “SIMULATED ENVIRONMENT COMPUTING FRAMEWORK”, filed Dec. 8, 2006, the entire disclosures of which are incorporated herein by reference.

### FIELD OF THE INVENTION

This application is related to computer networks and more particularly to simulated environments that utilize computer networks.

### BACKGROUND OF THE INVENTION

A simulated environment is one in which users can interact with each other via a computer. Users may appear on a screen in the form of representations referred to as avatars. The degree of interaction between the avatars and the simulated environment is implemented by one or more computer applications that govern such interactions as simulated physics, exchange of information between users, and the like. The number of users that can interact is largely dependent on the computing power available for the simulated environment.

It is within this context that embodiments of the invention arise.

### BRIEF DESCRIPTION OF THE DRAWINGS

The teachings of the present invention may be readily understood by considering the following detailed description in conjunction with the accompanying drawings, in which:

FIG. 1 is a block diagram of a simulated environment according to an embodiment of the present invention.

FIG. 2 is a flow diagram illustrating a method for making a function call with a processor and implementing the function call on a remote processor according to an embodiment of the present invention.

FIG. 3 is a block diagram of a simulated environment system according to an alternative embodiment of the present invention.

FIG. 4 is a block diagram of a cell processor based data center that may be used in conjunction with a simulated environment system according to an embodiment of the present invention.

### DESCRIPTION OF THE SPECIFIC EMBODIMENTS

Although the following detailed description contains many specific details for the purposes of illustration, anyone of ordinary skill in the art will appreciate that many variations and alterations to the following details are within the scope of the invention. Accordingly, the examples of embodiments of the invention described below are set forth without any loss of generality to, and without imposing limitations upon, the claimed invention.

Embodiments of the invention are related to very large simulated environments that may involve many users, e.g., hundreds of thousands of users or even millions of users. The computing resources required for such a vast simulated environment are considerably more than any single computer processor can provide. Consequently, embodiments of the present invention utilize a network of processor modules that can communicate with each other and with various networked user devices. Networked computing is largely limited by available bandwidth for transferring data between the processors simulating the environment and the user devices that allow users to interact with the simulated environment.

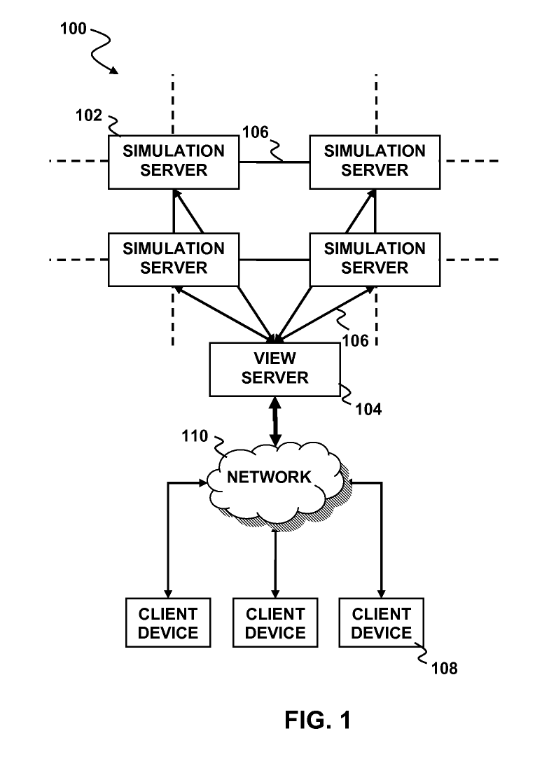

FIG. 1 is a block diagram illustrating a computing framework for simulating a large-scale environment. The framework is based on a data center 100 that includes one or more simulation servers 102 and one or more view servers 104. Each simulation server 102 is a processor module that executes coded instructions that simulate some part of the simulated environment. By way of example, each simulation server may be a multiple core processor, e.g., a dual-core, quad-core or Cell processor. Although a limited number of simulation servers 102 and a single view server 104 are depicted in FIG. 1, this configuration may be arbitrarily extended to any number of servers.

The numbers of simulation servers 102 and view servers 104 can both be scaled. For example one simulation server 102 may accommodate and many view servers 104, or many simulation servers 102 may accommodate one view server 104. Adding more simulation servers 104 allows for a bigger and/or better simulation of the virtual world. Adding more view servers 104 allows the data center 100 to handle more users. Of course, the data center may accommodate both a bigger and better simulation and more users add more of both simulation servers 102 and view servers 104. Theoretically the number of simulation servers 102 is infinitely scalable given a certain level of network bandwidth, and the number of view servers 104 will hit a limit after a certain number of users due to computation and network bandwidth limitations.

For the purpose of example, and without limitation of embodiments of the invention examples will be described herein with respect to Cell processors. Cell processors are described in detail, e.g., in Cell Broadband Engine Architecture, copyright International Business Machines Corporation, Sony Computer Entertainment Incorporated, Toshiba Corporation Aug. 8, 2005 a copy of which may be downloaded at http://cell.scei.co.jp/, the entire contents of which are incorporated herein by reference.

A typical Cell processor has a power processor unit (PPU) and up to 8 additional processors referred to as synergistic processing units (SPU). Each SPU is typically a single chip or part of a single chip containing a main processor and a co-processor. All of the SPUs and the PPU can access a main memory, e.g., through a memory flow controller (MFC). The SPUs can perform parallel processing of operations in conjunction with a program running on the main processor. The SPUs have small local memories (typically about 256 kilobytes) that must be managed by software—code and data must be manually transferred to/from the local SPU memories. For high performance, this code and data must be managed from SPU software (PPU software involvement must be minimized). There are many techniques for managing code and data from the SPU. Examples of such techniques are described e.g., in U.S. patent application Ser. No. 11/238,077 to John P. Bates, Payton White and Attila Vass entitled “CELL PROCESSOR METHODS AND APPARATUS”, filed Sep. 27, 2005 and published as US Patent Publication Number 2007/0074212A1; U.S. patent application Ser. No. 11/238,095 to Richard B. Stenson and John P. Bates entitled “CELL PROCESSOR TASK AND DATA MANAGEMENT” filed Sep. 27, 2005 and published as US Patent Publication Number 2007/0074221A1; U.S. patent application Ser. No. 11/238,086 to Tatsuya Iwamoto entitled “OPERATING CELL PROCESSORS OVER A NETWORK” filed Sep. 27, 2005 and published as US Patent Publication Number 2007/0074206A1; U.S. patent application Ser. No. 11/238,087 to John P. Bates, Payton R. White, Richard B. Stenson, Howard Berkey, Attila Vass, Mark Cerny and John Morgan entitled “SPU TASK MANAGER FOR CELL PROCESSOR” filed Sep. 27, 2005 and published as US Patent Publication Number 2007/0074207; U.S. patent application Ser. No. 11/257,761 to Tatsuya Iwamoto entitled “SECURE OPERATION OF CELL PROCESSORS” filed Oct. 24, 2005 and published as US Patent Publication Number 2007/0083755A1; U.S. patent application Ser. No. 11/461,390 to John P. Bates, Keisuke Inoue and Mark Cerny entitled “CELL PROCESSOR METHODS AND APPARATUS”, filed Jul. 31, 2006 and published as US Patent Publication Number 2007/0198628A1, the entire contents of all of which are incorporated herein by reference.

The simulation servers 102 can communicate with each other and with the view servers 104 via high speed data transfer links 106. By way of example, the data transfer links may be 10 gigabit per second Ethernet connections. As used herein, the term Ethernet generally refers to a family of frame-based computer networking technologies for local area networks (LANs). By way of example, and without loss of generality an Ethernet connection may be implemented as a wired connection. A wired Ethernet connection may be established according to collection of standards, e.g., as set forth in IEEE 802.3.

To optimize data transfer the simulation servers 102 and 104 may be located in fairly close physical proximity, e.g., within the same room or on the same server rack. The view servers 104 may be configured to receive simulation data from one or more of the simulation servers 102 and send view data to one or more remotely distributed client devices 108, e.g., over a wide area network 110, such as the Internet. The client devices may be any suitable device that can communicate over the network 110. Typically, communication over the network 110 is slower than over the fast data links 106. By way of example, the client devices 108 may be video game console devices, such as the Sony PlayStation 3. Alternatively, the client devices 108 may be any computer device from handheld to workstation, etc. A handheld video game device, such as a PlayStation Portable from Sony Computer Entertainment of Tokyo, Japan is one example among others of a handheld device that may be used as a client device 108 in embodiments of the present invention. The client devices 108 may send the view servers 104 instructions relating to their desired interaction with other clients' avatars and with the simulated environment. For example, a client user may wish to move his or her avatar to a different portion of the simulated environment. The client 108 sends instructions to one of the view servers 104. These instructions are relayed by the view servers 104 to the simulation servers 102 that perform the necessary computations to simulate the interactions.

The users of the client devices 108 are often interested in things around them. The view servers 104 make sure that each client 108 receives relevant data about its surroundings in the proper order. The view servers 104 determine what a user's client device needs based on its avatar's location, orientation, motion, etc.

A back end server such as a simulation server 102 or view server 104 often has more data than a single client device 108. Therefore, the back end server can make better decisions than the client 108. For example, in the case of file downloads, such as music downloads, a server could suggest that a client download desired file from a nearby peer who has the file. In addition, the back end server could keep track of the state of server-controlled avatars. For example if a user-controlled avatar crashes into server-controlled avatar, the color of either or both avatars may change to indicate that they have been involved in a collision.

The back end server could also analyze metadata to simulate a social network. For example, the server could identify a style of music (e.g., Jazz, classical, etc.) in music sent in a wave file from one client device 108 to another. The back end server could then suggest that these users of these devices contact other users that have shared similar music.

To implement such a complex simulated world, it is desirable to establish peer-to-peer communication between clients and servers or between clients and other clients. Embodiments of the invention may make use of Peerlib to traverse network address translators (NATs) by allowing peer-to-peer connections to be established. NAT traversal is described e.g., in U.S. patent application Ser. No. 11/243,853 to Yutaka Takeda, entitled “PEER-TO-PEER COMMUNICATION TRAVERSING SYMMETRIC NETWORK ADDRESS TRANSLATORS” filed Oct. 4, 2005 and published as US Patent Publication Number 2007/0076729A1, which is incorporated herein by reference.

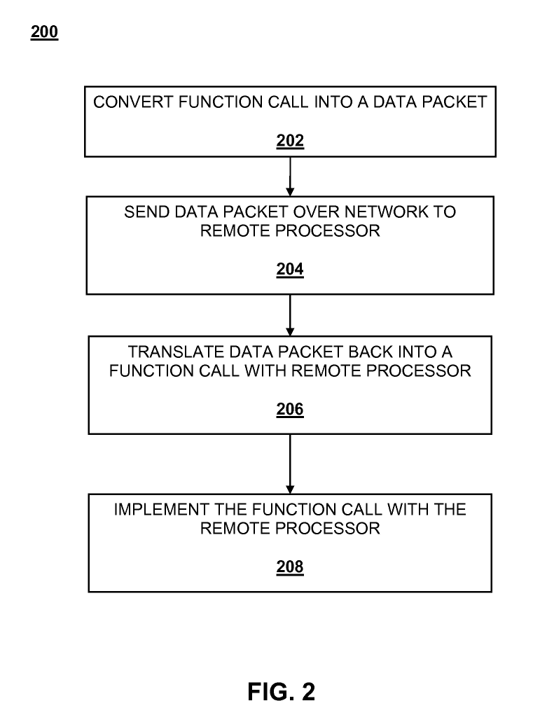

In addition, it is desirable to implement distributed parallel processing systems and architectures in such a way that function calls may be invoked over a network. For example, in embodiments of the invention a client device may invoke a function call on a remotely located server. An example of such a distributed parallel processing system is referred to herein as distributed SPU runtime system (SPURS). In SPURS, the memory of each SPU has loaded into it a kernel that performs scheduling of tasks in a task module handled by the SPU. Distributed SPURS adds to this a distributed method invocation (DMI), which facilitates function calls over a network. As shown in FIG. 2, a DMI method 200 converts a function call into a network packet as indicated at 202. The network packet may be sent over a network to a remote machine, as indicated at 204. The remote machine may then translate the network packet back into a function at 206. The remote machine may then execute the translated function call at 208 as it would any normal function call. In a cell processor context, the combination of DMI and SPURS allows direct SPU to SPU communication across a network. Complex tasks may be distributed amongst available processing resources where it is advantageous to do so. A number of criteria may affect whether it is more efficient to distribute or not to distribute at given task. A discussion of systems and methods for deciding whether or not to distribute a task may be found in U.S. patent application Ser. No. 11/459,301, to John P. Bates and Payton R. White, filed Jul. 21, 2006, 2006 and entitled “SUB-TASK PROCESSOR DISTRIBUTION SCHEDULING”, the entire contents of which are incorporated herein by reference.

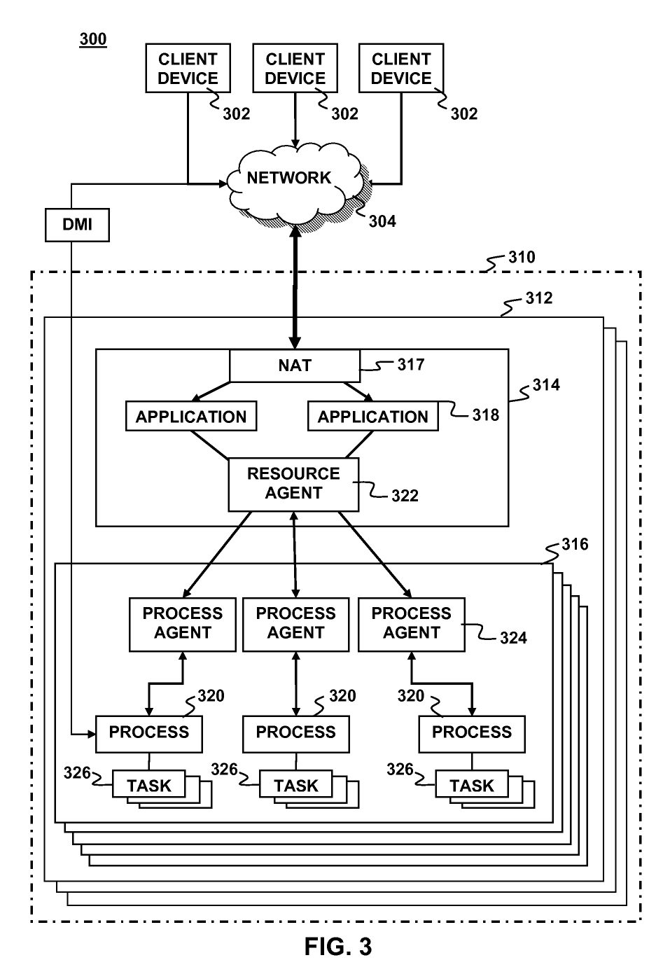

FIG. 3 illustrates one possible implementation of a simulated world system 300 according to an embodiment of the present invention. In the system 300 client devices 302 communicate over a network 304 with each other and with a data center 310. The data center contains a plurality of node groups 312. Each node group 312 includes server front end 314 and one or more server nodes 316. A network address translator (NAT) 317 and one or more applications 318 reside at the server front end 314. The applications 318 direct queries from the client devices 302 for implementing processes 320 on the server nodes 316 to a resource agent 322. Each process 320 may be implemented as a set of processor tasks 326. The resource agent 322 distributes the queries among the various server nodes 316. Process agents 324 residing at each server node 316 advertise their available processing resources to the resource agent 322 at the server front end 314.

When a given client device 302 wishes to implement a particular process at the data center 310, the client device 302 must first traverse the NAT 317, e.g., as described in U.S. patent application Ser. No. 11/458,301, to transmit a query to an application 318. The resource agent 322 and process agents 324 assign the query to a particular process 320 running on a particular server node 316. Once the application 318 notifies the client device 302 of this assignment, the client device 302 may send peer-to-peer function calls to the process 320 using DMI.

It is noted that, in some embodiments, the clients 302 may include resource agents and process agents to that the data center 310 and/or other clients may utilize available client processing resources.

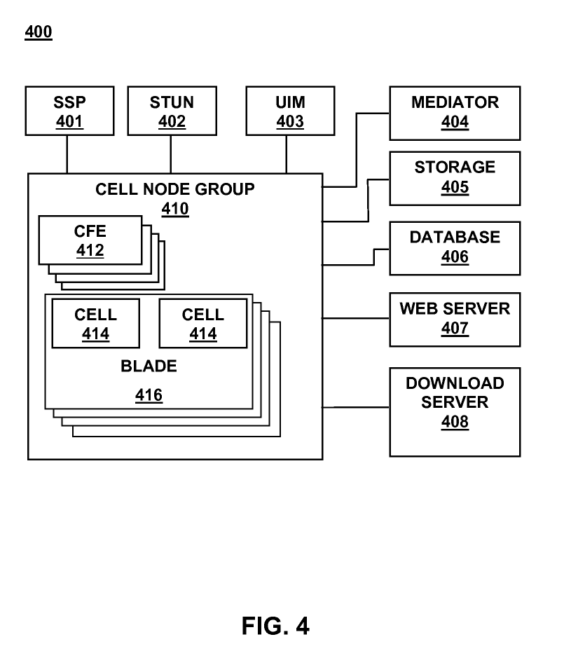

There are a number of different processor architectures that may be used to implement the data center 310. Such processor architectures may be built around single core, dual core or multiple core (e.g., quad-core or cell processor) architecture. By way of example, and without loss of generality, FIG. 4 depicts an example of a cell processor based data center 400 according to an embodiment of the present invention. In this example, the data center 400 may include a server-to-server protocol (SSP) 401, a STUN server 402, a universal identity manager (UIM) 403 a mediator 404, data storage 405, a data base 406, one or more web servers 407, one or more download servers 408 and a plurality of cell node groups 410.

The STUN server 402 and SSP 401 may facilitate NAT traversal. STUN is an acronym for Simple Traversal of User Datagram Protocol (UDP) Through Network Address Translators (NATs). STUN is a network protocol allowing a client behind a NAT (or multiple NATs) to find out its public address, the type of NAT it is behind and the internet side port associated by the NAT with a particular local port. This information is used to set up UDP communication between two hosts that are both behind NAT routers. The protocol is defined in RFC 3489, which is incorporated herein by reference. The UIM 403 tracks user identity and gives each user (or client device) a unique token to verify the user's identity. Following NAT traversal and token assignment by the UIM 403, remote client devices may communicate with the mediator 404, e.g., via DMI. The mediator 404 stores registered application information and provides this information to client devices. By way of example, the mediator 404 may provide a universal resource locator (URL) from which the client device may download application code and data.

The storage system 405 may store and retrieve data for processes running on the cell node groups. By way of example, the storage 405 may be a clustered file system, such as the general parallel file system (GPFS) developed by IBM. The database 406 web servers 407 and download servers 408 may perform conventional functions in support of processes running on cell processors within the cell node groups 410.

The database 406 may contain application data such as multimedia content, executable binary code, etc. The database 406 may also contain user account information, billing information, virtual world state (location of Items, Monsters, etc). Other information that may be stored in the database 406 includes user statistics: amount of time spent using each application, average duration of each application usage, favorite locations within the virtual world, “buddies”, etc.

Each cell node group 410 may include one or more cell front ends 412 and a plurality of cell processors 414. Each cell front end may be a single core processor, e.g., an Intel x86-type processor capable of 10 gigabit bandwidth communication with the cell processors 414. By way of example, pairs of cell processors may be fabricated on the same substrate in a configuration known as a cell blade 416. The cell processors 414 may be a plurality of such blades 416. Each cell blade may be a rack mounted and self-contained for easy scalability. Typically about 8 to 12 cell blades 416 may be associated with each cell front end 412. By way of example, and without loss of generality, a cell node group 410 may include four cell front ends 412 and 48 cell blades.

In certain embodiments of the present invention cell processor hardware may be used to implement both the view servers 104 and simulation servers 102. The cell front end 412 communicates with the resource agent 322 to acquire appropriate cell blades 416 for the view servers 104 and simulation servers 102 described above with respect to FIG. 1. In another possible implementation cell processors may be used to implement the simulation servers 102 described above and the x86 cell front ends may implement the view servers 104.

The process tasks are typically distributed amongst the available SPU of the cell processors 414 within the cell node group 410. The PPU of each cell 414 may be utilized specifically for servicing the network with which the cell is associated.

In some embodiments one or more of the cells 414 may be configured, e.g., by suitable programming, to implement function calls over a network, e.g., in conjunction with a method of the type described above with respect to FIG. 2. In particular a cell 414 (or other processor) may be configured to receive a function call that has been translated into a data packet from another processor over the network; translate the data packet back into the function call; and implement the function call. Alternatively, a cell (or other processor) may be configured (by appropriate programming) to convert the function call into a data packet; and send the data packet over the network to a remote processor that is configured to translate the data packet back into the function call and implement the function call. These functionalities may also be implemented with the simulation servers 102, view servers 104 or client devices 108 described above with respect to FIG. 1 or with one or more of the server nodes 316 described above with respect to FIG. 3.

While the above is a complete description of the preferred embodiment of the present invention, it is possible to use various alternatives, modifications and equivalents. Therefore, the scope of the present invention should be determined not with reference to the above description but should, instead, be determined with reference to the appended claims, along with their full scope of equivalents. Any feature described herein, whether preferred or not, may be combined with any other feature described herein, whether preferred or not. In the claims that follow, the indefinite article “A”, or “An” refers to a quantity of one or more of the item following the article, except where expressly stated otherwise. The appended claims are not to be interpreted as including means-plus-function limitations, unless such a limitation is explicitly recited in a given claim using the phrase “means for.”

What is claimed is:

1. An apparatus for implementing a simulated environment, comprising:
a plurality of simulation servers coupled to each other over data transfer links, the simulation servers being configured to perform computations related to simulating an environment; and
a plurality of view servers coupled to the simulation servers over fast data transfer links, wherein each view server is configured to facilitate interaction between a plurality of client devices and the simulation servers, wherein each user device controls an avatar within the simulated environment.

2. The apparatus of claim 1 wherein each simulation server includes a multiple core processor.

3. The apparatus of claim 1 wherein one simulation server of the plurality is configured to accommodate a plurality of view servers.

4. The apparatus of claim 1 wherein two or more simulation servers of the plurality are configured to accommodate a single view server.

5. The apparatus of claim 1 wherein at least a subset of the plurality of view servers are located within close physical proximity to each other.

6. The apparatus of claim 1 wherein each view server is configured to receive simulation data from one or more of the simulation servers, and wherein each view server is configured to send view data to one or more of the client devices.

7. The apparatus of claim 6 wherein the client devices include one or more video game console devices.

8. The apparatus of claim 6 wherein the client devices include one or more handheld devices.

9. The apparatus of claim 6 wherein each view server is configured to receive instructions from a particular client device relating to a desired interaction between an avatar associated with the particular client device with one or more other avatars associated with one or more different client devices.

10. The apparatus of claim 1 wherein one or more of the view servers are configured to determine a user's needs based on a location, orientation or motion of the user's avatar within the simulated environment.

11. The apparatus of claim 1 wherein at least one of the view servers or simulation servers is configured to suggest that a given one or more of the client devices download one or more desired files from one or more nearby peer client devices that have the one or more desired files.

12. The apparatus of claim 1 wherein at least one of the view servers or simulation servers is configured to keep track of a state of one or more avatars associated with a subset of the client devices for which the at least one of the view servers or simulation servers are responsible.

13. The apparatus of claim 1 wherein at least one of the view servers or simulation servers is configured to also analyze metadata in one or more files transferred between two or more client devices and suggest to the users of the two or more client devices other users who have shared similar files.

14. The apparatus of claim 1 wherein one or more of the client devices of the plurality of client devices is configured to establish peer-to-peer communication between one or more of the view servers, one or more of the simulation servers or one or more other client devices of the plurality of client devices.

15. The apparatus of claim 1 wherein one or more of the simulation servers, one or more of the view servers or one or more of the client devices is configured to invoke a function call over a network on a remote device.

16. A simulated world system, comprising:
a data center configured to communicate over a network with one or more remotely distributed client devices;
wherein the data center includes a plurality of node groups, wherein each node group includes a server front end, having a network address translator, one or more applications and one or more server nodes and a resource agent, wherein the applications are configured to direct one or more queries from the client devices for implementing one or more processes on the server nodes to the resource agent, wherein the resource agent is configured to distribute the queries among the one or more server nodes.

17. The simulated world system of claim 16 wherein each server node is configured to implement one or more of the processes is implemented as a set of processor tasks.

18. The simulated world system of claim 17, wherein each of the one or more server nodes includes one or more process, wherein each process agent is configured to advertise its available processing resources to the resource agent.

19. The system of claim 18 wherein the resource agent and process agent are configured to assign a particular one of the one or more queries to a particular process running on a particular one of the one or more server nodes.

20. The system of claim 19 wherein one or more of the applications is configured to notify a particular one of the client devices of an assignment of the particular one of the one or more queries to the particular process.

21. The system of claim 20 wherein the process is configured to receive function calls from the particular one of the client devices after the particular one of the client devices has been notified of the assignment.

22. The system of claim 16, wherein the data center, further comprises:
a server-to-server protocol (SSP) and a STUN server operably coupled to the one or more node groups;
universal identity manager (UIM) operably coupled to the one or more node groups;
a mediator operably coupled to the one or more node groups;
a data storage device operably coupled to the one or more node groups;
a database operably coupled to the one or more node groups;
one or more web servers operably coupled to the one or more node groups; and
one or more download servers operably coupled to the one or more node groups.

23. A method for making a function call with a processor and implementing the function call on a remote processor, wherein the processor and remote processor are connected to a network, comprising:
converting the function call into a data packet with the processor;
sending the data packet over the network to the remote processor;
translating the data packet back into a function call with the remote processor; and
implementing the function call with the remote processor.

24. An apparatus for remotely implementing a function call, comprising:
a remote processor configured to connect to a network, wherein the remote processor is configured to:
a) receive a function call that has been translated into a data packet from another processor over the network;
b) translate the data packet back into the function call; and
c) implement the function call.

25. An apparatus for remotely implementing a function call, comprising
a processor configured to connect to a network, wherein the processor is configured to
a) convert the function call into a data packet; and
b) send the data packet over the network to a remote processor that is configured to translate the data packet back into the function call and implement the function call.
